(19) United States
(12) Patent Application Publication
(10) Pub. No.: US 2025/0223070 A1
(43) Pub. Date: Jul. 10, 2025

(54) METHOD AND SYSTEM FOR DETECTING AND RESOLVING MALFUNCTIONS OF A MACHINE

(71) Applicant: Krones AG, Neutraubling (DE)

(72) Inventor: Christoph BOGNER, Neutraubling (DE)

(21) Appl. No.: 19/001,262

(22) Filed: Dec. 24, 2024

(30) Foreign Application Priority Data
Jan. 9, 2024 (DE) 102024100433.9

(51) Int. Cl. B65B 57/18; B65B 25/00; G06F 11/07

(52) U.S. Cl. CPC B65B 57/18; G06F 11/0769; G06F 11/0793; B65B 25/001

(57) ABSTRACT

The disclosure relates to a method and system for detecting and resolving malfunctions of a machine, in particular a machine in a machine line for filling and packaging food and/or beverages. The method starts with receiving a sensor signal from the machine. The sensor signal can indicate a malfunction of the machine and comprise a context of the malfunction. Instructions for resolving the malfunction are then identified, which are selected from an instructions database based on the context of the malfunction. An operator of the machine is notified and receives information about the malfunction of the machine and at the same time the identified instructions for resolving the detected malfunction. The operator has the option to create modified instructions for resolving the machine malfunction and send it back to the database. The modified instructions are then stored in the instructions database and linked to the sensor signal, making them identifiable via the context of the malfunction.

### CROSS REFERENCE TO RELATED APPLICATION

The present application claims priority to German Patent Application No. 10 2024 100 433.9 filed on Jan. 9, 2024. The entire contents of the above-listed application are hereby incorporated by reference for all purposes.

### TECHNICAL FIELD

The disclosure relates to a method and system for detecting and resolving malfunctions of a machine, in particular a machine in a machine line for filling and packaging food and/or beverages.

### BACKGROUND

The increasing complexity of machine lines, in particular in machine lines for filling and packaging food and/or beverages, constitutes a significant problem when it comes to maintenance and malfunction diagnosis. Modern filling plants are characterized by a plurality of individual components and their interactions, which makes locating and resolving errors a challenging and time-consuming task. Current methods for resolving errors are often not sufficient to meet the increased demands.

### SUMMARY

Known documentation systems, usually in the form of extensive PDF files, are not only difficult to manage but also static. They offer little support for interactive problem solving and are often not up to date with the corresponding plant configuration. Operators often have to work through many pages of text and diagrams to find specific information, which takes up valuable time and increases the risk of overlooking relevant information. This approach is particularly problematic in case of unforeseen errors that lie outside the standard procedures.

Furthermore, the process of searching and resolving errors is often an isolated event. Even if an operator successfully solves a problem, the solution is rarely documented in a way that is accessible or understandable to other operators. This leads to inefficient knowledge transfer and repetition of processes of resolving errors for similar or identical problems in the future. The lack of an integrated system for detecting and documenting errors prevents the development of a knowledge base that is essential for continuous improvement and rapid response times.

Current systems therefore often have the disadvantages of high time expenditure for problem diagnosis and solution, inefficient use of knowledge and experience and a limited ability to adapt to new or changed plant configurations. These factors can lead to longer downtime, increased operating costs and reduced flexibility in production.

There is hence a need for a solution that overcomes these disadvantages in the prior art and thus provides an efficient dynamic technique for detecting and resolving machine malfunctions of filling and packaging machines, lines and plants based on a digital twin.

This object is achieved according to the disclosure by a and a system as described herein.

One embodiment of the disclosure relates to a method for detecting and resolving malfunctions of a machine, in particular a machine in a machine line for filling and packaging food and/or beverages. The method starts with receiving a sensor signal from the machine. The sensor signal can indicate a malfunction of the machine and comprise a context of the malfunction. Instructions for resolving the malfunction are then identified, which are selected from an instructions database based on the context of the malfunction. An operator of the machine is notified and receives information about the malfunction of the machine and at the same time the identified instructions for resolving the detected malfunction. The operator has the option to create modified instructions for resolving the machine malfunction and send it back to the database. The modified instructions are then stored in the instructions database and linked to the sensor signal, making them identifiable via the context of the malfunction.

Another embodiment of the disclosure relates to a system that implements the method.

### BRIEF DESCRIPTION OF THE FIGURES

Example aspects of the disclosure are shown in the drawings. In the drawings:

FIG. 1 shows a diagram showing an overview of the essential elements and the basic structure of the disclosure;

FIG. 2 shows an exemplary user interface for displaying and editing instructions;

FIG. 3 shows an exemplary plant configuration for PET containers and adhesive containers;

FIG. 4 shows an exemplary plant configuration for PET containers and shrink packers;

FIG. 5 shows an exemplary plant configuration for cans or glass bottles; and

FIG. 6 shows an exemplary plant configuration for cans.

### DETAILED DESCRIPTION

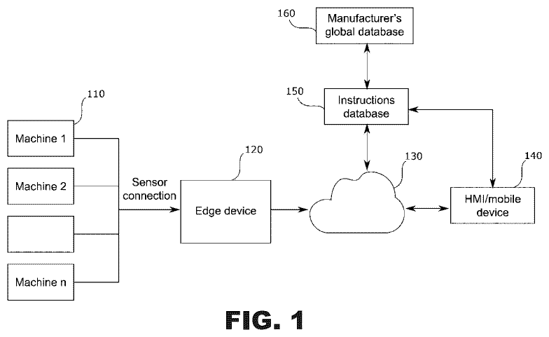

The disclosure aims at providing not only more efficient error detection, but also a targeted solution strategy for resolving the detected machine error. FIG. 1 shows an overview of the essential elements and the basic structure of the disclosure. A machine plant according to embodiments comprises one or more machines 110 connected to an edge apparatus 120 via a sensor connection.

According to embodiments, machine problems or malfunctions of a machine 110 can be measured using sensors. The sensor values can then be transmitted via the edge apparatus 120 to a computer 130, such as a server or cloud, for further processing.

The sensors connected to the machines 110 can measure different physical and operational parameters that can be used for condition monitoring and fault detection. Different sensors such as vibration sensors, temperature sensors, pressure sensors and/or flow meters can be strategically placed at critical points of the machine. For example, vibration sensors can detect irregularities in the operation of bearings or gears, while temperature sensors can identify overheated components. It should be noted that these sensors are only examples and that many other types of fault detection using sensors can be used here.

When the collected data are transmitted to the edge apparatus 120, the edge apparatus can provide context to the sensor signals to effectively use the sensor data for fault diagnosis. According to embodiments, the sensor signals can be provided with context already when they are created at the sensor of the corresponding machine 110.

The context can be an indication of a type of error, an indication of an affected component and/or a specific parameter that deviates from a normal state. The context may include identification of the specific machine 110 or component, the environmental conditions, and/or the operational state at the time of data collection. For example, each sensor can be assigned a unique ID that assigns it to a specific machine or component. According to embodiments, sensors can also collect additional data such as room temperature, humidity or operating times to record the general conditions of operation, or operating modes such as load conditions, speeds or production numbers can be recorded together with the sensor data. There are different ways to determine, using the sensor values, whether the machine is malfunctioning.

The sensor data, along with the context, can be sent from the edge apparatus 120 to the server 130 in real time or at set intervals. Data transmission can take place via wired networks (Ethernet), via the Internet or using wireless technologies (WLAN, Bluetooth, ZigBee).

The logic for detecting machine problems and malfunctions of the machine 110 can be executed on the machine 110 itself or on the server 130. For example, software in server 130 can use machine learning and/or pattern recognition algorithms to draw conclusions from the sensor data and context and identify errors.

To resolve and correct the malfunction, the server 130 can access an instructions database 150 containing a plurality of different instructions. The instructions database can be implemented in the server 130, or can be implemented separately in another computer apparatus. By analyzing the context, one or more instructions can be identified in the instructions database 150 that are suitable for resolving the malfunction of the machine 110.

According to embodiments, this enables efficient and systematic error resolution by automatically providing the relevant repair and maintenance instructions for the identified problems. The sensor data and/or the context of the sensor data can be compared with entries in the solutions database 150, wherein the context of the sensor signals is taken into account when identifying instructions. The instructions database 150 comprises a plurality of approaches and instructions for different malfunctions, for example classified by machine type, error type and/or context.

As soon as a suitable solution or suitable instructions are found in the instructions database 150, the corresponding instructions can be presented to an operator, for example by sending the instructions together with the error message to the HMI or mobile apparatus 140. In this example, both the error message about the detected fault on the machine 110 and the identified instructions for resolving the malfunction can be sent to the operator's HMI or mobile apparatus 140 at the same time. However, the error message and solution instructions do not necessarily have to be sent to the operator at the same time. The operator can also manually select via the HMI or mobile apparatus 140 that they are requesting a resolution of the problem.

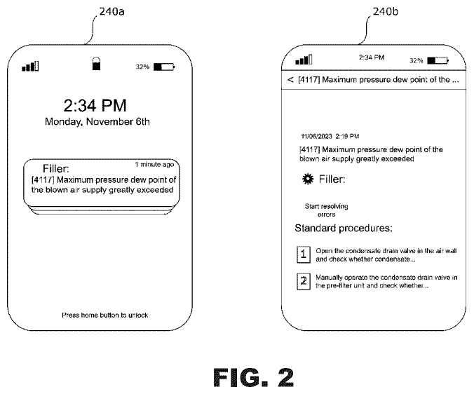

The presentation can be done via a user interface of the mobile apparatus, as exemplified in FIG. 2 and discussed below. The instructions can be step-by-step instructions that can provide clear, understandable error resolution instructions one after another. The instructions can also comprise pictures, diagrams and videos that illustrate the steps. This allows the operator to see all the steps of the instructions one after another so that they can focus on the step that actually needs to be carried out. For example, an operator can use a swipe gesture on a touch-sensitive screen to navigate between steps or jump to the next instruction when the steps of the previous instruction are completed.

The instructions database 150 contains both individual recommendations and instructions created by customers and standard instructions that are based on the industry knowledge integrated by a manufacturer (technical documentation).

These instructions can be accessed by operators and other workshop personnel during troubleshooting. In addition to accessing the entire database, the instructions are suggested in a context-related manner based on the machine problems that have occurred/are pending, as described.

According to embodiments, it is also possible for operators to create or modify instructions themselves. For example, an operator can modify and/or amend instructions in the instructions database via the HMI or mobile apparatus 140 and send it back to the instructions database 150. The modified instructions can be stored in the instructions database 150 such that the stored modified instructions are linked to the sensor signal and are identifiable using the context of the malfunction.

According to embodiments, the modified instructions can comprise one of the following features: an added and/or removed comment, and/or additional instructions for action to be taken by an operator, and/or a modified sequence of instructions for action, and/or alternative or corrective indication on existing instructions for action or on an existing comment. Storing the modified instructions can comprise validating one or more correlated data points in the instructions. The relevant rules can be adapted to the individual needs and working conditions in the production line.

These amendments or modified instructions, which are stored in the instructions database 150, can thus be linked by the operator to the original problem (e.g., to the sensor signal) and can be suggested by the system the next time the problem occurs.

In general, when creating instructions, the operator can start by describing the first step, which can be automatically incorporated into the title of the entire problem solution to make content creation as easy as possible. Instructions can be created in general or with respect to a specific context (relationship between touch messages and data point(s)). If created in relation to a machine problem, the created instructions can comprise a reference to the relevant machine data (e.g., machine message, condition-based maintenance (CbM) rule, line control event).

According to embodiments, an approval method can be implemented for later development steps to sort out potentially malicious or erroneous instructions. Modified instructions can be marked visually or textually to show an operator that the instructions are not instructions created by the manufacturer.

According to embodiments, the instructions in the instructions database 150 can have a standardized form and format. Instructions begin with a title that shows the content as clearly and unambiguously as possible. This ensures that an operator can immediately recognize what the instructions are about. An optional description can provide additional information and context to help the operator better understand the relevance and scope of the instructions.

All instructions can be assigned to a specific category to make it easier to find them in the database. These categories, such as troubleshooting, maintenance, cleaning, lubrication or changeover, can be defined by a user and help to speed up the search and retrieval of the corresponding instructions.

For further specification and targeted use, references to the equipment can be included in the instructions. These references can extend across different levels of the company, from the overall organization down to the specific machine within a production line. This allows for granular assignment and application of the instructions.

Appendices can supplement the instructions by providing additional resources such as diagrams, photos or videos. The instructions are structured as steps that guide the user through the process for resolving errors. This step-by-step approach is configured to reduce complexity and ensure that all necessary actions are carried out in the correct order.

The administrative information in the instructions that can be automatically performed by the system includes information about the creator of the instructions and the date of creation and last modification. This information is important not only for traceability and documentation, but also for quality assurance and maintenance history management. This structured approach ensures that instructions for resolving malfunctions are not only effective and efficient, but also easier to manage and search, which can support smooth operations and simplify maintenance work.

Users can search the list of available instructions using search criteria, for example. For example, a free text search by title and description can be applied and/or useful suggestions and auto-complete functions can be implemented by the system. This can help users find what they are looking for more easily. The search function within the database 150 can also comprise different filter criteria, such as “equipment” (any equipment level can be selected (e.g., company, division, machine)), “category.”

There can also be several solutions or instructions available in the database 150 or 160 for a malfunction in a machine 110. Identifying the instruction(s) for resolving the malfunction can comprise the steps of identifying a plurality of instructions relevant to the context of the sensor signal and providing a selection of the multitude of instructions to the operator.

In addition to individually generated instructions, there is also the possibility of integrating general solution descriptions from a manufacturer's technical documentation. Solution descriptions (for example from a global database 160) can be extracted from a manufacturer's technical documentation (e.g., using artificial intelligence) and integrated as part of the instructions database 150.

According to embodiments, a QR code can be automatically generated for instructions in the instructions database 150. These QR codes can, for example, be printed out and attached to respective machines. The relevant instructions can be opened by scanning the QR code with the camera of the mobile apparatus 140.

According to embodiments, the system can also automatically translate selected instructions into a language selected by the user.

According to further embodiments, the system can also comprise the possibility of rating instructions. The operating personnel can also be given the opportunity to rate the instructions. Rating options can include, for example, “The instructions are useful (I like them),” “The instructions are generally useful,” “The instructions are useful in relation to a problem that has occurred,” etc. In addition, textual feedback can also be provided. These ratings can be used to provide a ranking if there are multiple instructions for resolving a malfunction. The quality can also be improved.

These user interactions can also be used as the basis for an incentive scheme. If there are instructions related to problems encountered, the workshop staff can rate the suggested instructions. Based on this rating, the system lists the instructions sorted by the user's rating (in most cases, the artifact displayed first solves the problem).

The system improves as more content is available that is created by operators in production. An incentive for operators to create even more solutions could be to send push notifications in certain situations, such as “Someone liked an instruction because it was helpful” or “Someone amended an instruction.” In some embodiments, a user ranking can be implemented which shows the users with the most instructions created or the best instructions.

According to further embodiments, artificial intelligence can be implemented if the instructions database 150 does not suggest a suitable solution. For example, solutions could be searched for using applications such as large language models that were previously trained using technical documentation for the machine 110.

FIG. 2 shows two views 240a and 240b of a mobile apparatus 140 according to exemplary embodiments. As shown in view 240a, when a malfunction of a machine 110 is detected, a push message can be sent to the mobile apparatus, whereby an operator in charge is immediately notified. The operator can select the message and can thereby be provided with further information, as seen in view 240b. The operator can immediately start resolving errors by selecting and following the instruction(s) displayed at the same time. The operator can change the instructions directly using the mobile apparatus 140 and send them back to the database 150.

Embodiments of the disclosure have several advantages compared to previous systems. Linking instructions and malfunctions allows for faster and easier access when troubleshooting. Mobile access, for example via the mobile apparatus 140, allows for location independence. Experience of the workshop personnel has a direct influence on the solutions database. Operators can integrate their own instructions.

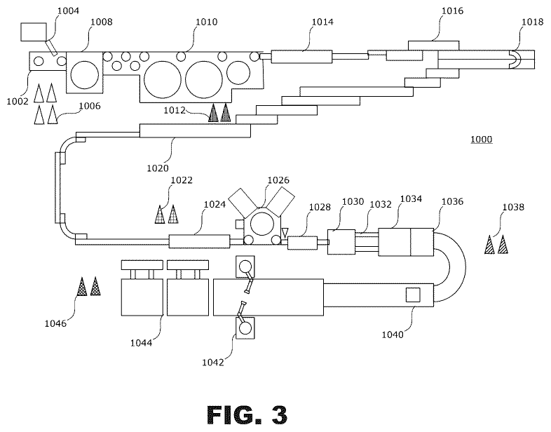

In the following FIGS. 3 to 6, various exemplary plant configurations for different bottle filling plants are described in which the disclosure or at least parts and aspects of the disclosure can be implemented. The description of FIGS. 3 to 6 is intended only to provide a general overview of machines for which state data can be collected, on the basis of which the LLM can process user requests.

FIG. 3 shows an exemplary plant configuration 1000 for PET bottles or PET containers and adhesive containers. As can be seen in FIG. 3, the plant configuration 1000 comprises the most varied modules, which form a line at the end of which the ready-filled PET containers are dispensed in the form of a bundle on pallets. Some of the modules and machines can be optional, and the disclosure is not limited to the exact shape and arrangement of the plant configurations.

The plant configuration 1000 comprises a furnace 1002 for preforms, a preform sorting system with a feeding machine 1004, and a blow-molding machine 1008. Modules 1002, 1004, and 1008 form in general a stretch blow-molding machine in which PET containers are manufactured and formed from a raw material. The produced PET containers are forwarded to a filler 1010 in which the bottles are filled. The filler can optionally comprise a rinser. Various particles such as dust, cardboard, or remains of wooden pallets can collect in the preforms during storage or transport. These can be removed with the rinser. At the end of the filler, a closer can be arranged, by means of which the PET containers are closed after filling.

Optionally, the plant configuration 1000 can, after the filler 1010, comprise a rotating apparatus, which is used for hot filling of the PET containers. The filled PET containers are guided to a separator 1020 and further to a drying apparatus 1024 in which the PET containers are dried via one or more conveyor belts 1016, which can also comprise a buffer 1018 for intermediate loading of filled containers.

After drying, the PET containers are conveyed to a labeling machine 1026. The labeling machine 1026 can be configured for various labeling techniques such as labeling using hot glue, cold glue, self-adhesive labels, or sleeves. After printing or labeling the PET containers, the PET containers are passed through a second drying apparatus 1028, a line distributor 1030, conveyor belts 1032, adhesive container production 1034, and a curing section to a handle applicator. In adhesive packaging production 1034, the PET containers are grouped together in certain group sizes and packaged into a pack such as a “six-pack.” In the handle applicator, a carrying handle is attached to the pack, which allows the pack to be carried comfortably. The finished packs are then accordingly arranged by a robot 1042 for layer production and packed on pallets by a palletizer 1044.

In the plant configuration 1000, so-called format trolleys or format racks can be arranged on various modules and machines in order to provide quickly changeable format sets for short changeover times and automatic tool exchange. Examples of format trolleys are the format trolley 1006 for the blow-molding machine 1008, the format trolley 1012 for the filler 1010, the format trolley 1022 for the labeling machine 1026, the format trolley 1038 for the adhesive packaging production 1034, and the format trolley 1046 for the palletizer 1044.

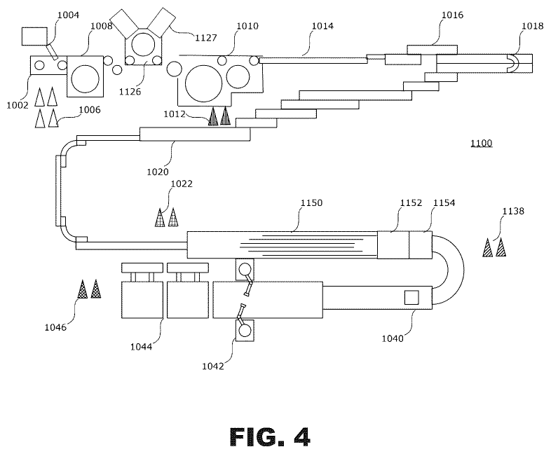

FIG. 4 shows another exemplary plant configuration 1100 for PET containers and shrink packers. The plant 1100 in FIG. 4 comprises many of the modules and machines from the plant configuration 1000 in FIG. 3, but there are some differences. The description of the modules that are already described in connection with FIG. 3 is therefore omitted for FIG. 4.

A key difference between the two exemplary plant configurations 1000 and 1100 is that the labeling machine 1126 with the labeling modules 1127 can already be installed after the blow-molding machine 1008 and before the filler 1008. For this purpose, the plant configuration 1100 can comprise six transport lanes 1150 into which the PET containers can be pushed. After the PET containers have been correspondingly pushed into one of the six lanes 1150, they are conveyed into the film wrapping module 1152 and then into the shrink tunnel 1154.

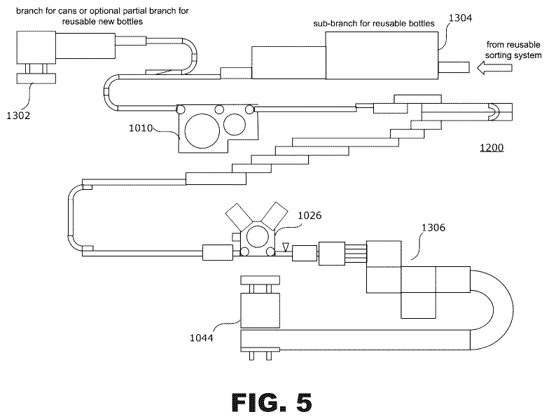

FIG. 5 shows an exemplary plant configuration 1200 for cans or glass bottles. The exemplary plant configuration 1200 from FIG. 5 again has some similarities to the plant configurations 1000 and 1100 from FIGS. 3 and 4, and the description of the plant configuration is therefore limited to the differences between the plant configurations.

As shown in FIG. 5, the exemplary plant configuration can comprise two separate feeds. A first feed, on the left in FIG. 5, shows a branch for cans or, optionally, a partial branch for reusable new bottles. The containers, i.e., cans or new bottles, are fed from a depalletizer 1302 into the machine, where they are guided via conveyor belts to the filler 1010. A second feed, on the right in FIG. 5, shows a partial branch for reusable bottles, which are introduced into the plant from a reusable sorting plant (not shown).

In the case where the reusable bottles that have already been used are introduced into the plant 1200 via the sub-branch for reusable bottles, the reusable bottles first pass through the cleaning machine or washing machine 1304. Another possible difference of the exemplary plant configuration 1200 is the transfer packer 1306 after the labeling machine 1026. The transfer packer can sort the bottles or cans into a carton clip application or into boxes, or both.

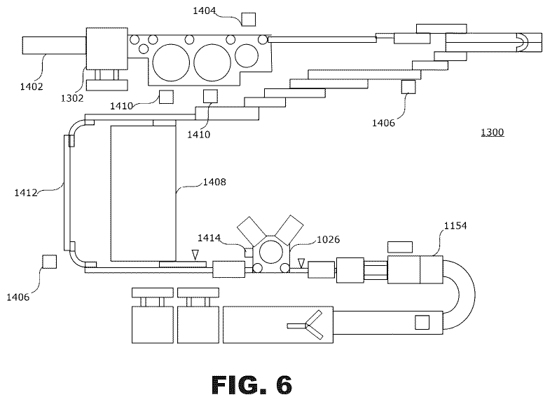

FIG. 6 shows an exemplary plant configuration 1300 for cans, in which the elements already described in the other plant configurations are not described. The cans in the plant configuration 1300 are introduced from a magazine 1402 with cans into the depalletizer 1302. The cans, after they have passed through the filler and are filled, are closed by means of a closure magazine 1404 and are then transported further along the plant 1400 via the conveyor belts as described above.

The optional pasteurizer 1408 can be circumvented via the bypass 1412 if it is not required. In the pasteurizer 1408, the freshly filled products can be pasteurized for preservation.

In contrast to the plant configurations 1000, 1100, and 1200, the exemplary plant configuration 1300 shows various tanks for corresponding consumables, such as the tanks 1410 with rinsing liquid and/or the filling product, and the tanks 1406 with belt lubricant. These tanks can also be contained in the above-described exemplary plant configurations. For example, the chemical products 106 that are fed from the mixer 110 to the machines can be stored in the tanks 1406 and 1410.

1. A method for detecting and resolving malfunctions of a machine, wherein the method comprises:
receiving a sensor signal from the machine, wherein the sensor signal indicates a malfunction of the machine and comprises a context of the malfunction;
identifying instructions for resolving the malfunction, wherein identifying the instructions comprises selecting the instructions from an instructions database based on the context of the malfunction;
creating a notification for an operator of the machine, wherein the notification comprises information about the malfunction of the machine and the identified instructions for resolving the detected malfunction;
issuing the notification to the operator;
receiving modified instructions to resolve the malfunction of the machine from the operator; and
storing the modified instructions in the instructions database, wherein the stored modified instructions are linked to the sensor signal and are identifiable using the context of the malfunction.

2. The method according to claim 1, wherein the modified instructions comprise at least:
an added and/or removed comment; and/or
additional instructions for action to be taken by an operator; and/or
a modified sequence of instructions for action; and/or
alternative or corrective indication on existing instructions for action or on an existing comment; and
wherein storing the modified instructions comprises validating one or more correlated data points in the instructions.

3. The method according to claim 1, wherein identifying the instructions for resolving the malfunction comprises:
identifying a plurality of instructions relevant to the context of the sensor signal; and
providing a selection of the plurality of instructions to the operator.

4. The method according to claim 1, further comprising:
automatically translating the instructions issued to the operator into a language selected by the user.

5. The method according to claim 1, further comprising:
validating the modified instructions before the modified instructions are identifiable using the context of the malfunction.

6. The method according to claim 1, wherein users have access to the instructions database and instructions in the instructions database are rateable by users to create a contextual ranking, and wherein instructions are selected based on context and based on the ranking.

7. The method according to claim 1, further comprising:
automatically generating a QR code that allows direct access to an instruction in the instructions database.

8. The method according to claim 1, wherein the instructions are step-by-step instructions that can be displayed on a mobile device.

9. The method according to claim 1, wherein the context comprises:
an indication of a type of error, an indication of an affected component and/or a specific parameter that deviates from a normal state.

10. A system for detecting and resolving malfunctions of a machine, wherein the system comprises:
one or more machines;
one or more sensors configured to measure data from the one or more machines;
an edge apparatus configured to receive the data from the one or more sensors as sensor data;
a computer apparatus connected to the edge apparatus, wherein the computer apparatus comprises an instructions database and wherein the computer apparatus is configured to:
receive the sensor signal from the machine, wherein the sensor signal indicates a malfunction of the machine and comprises a context of the malfunction;
identify instructions for resolving the malfunction, wherein identifying the instructions comprises selecting the instructions from the instructions database based on the context of the malfunction;
creating a notification for an operator of the machine, wherein the notification comprises information about the malfunction of the machine and the identified instructions for resolving the detected malfunction;
issuing the notification to the operator;
receiving modified instructions to resolve the malfunction of the machine from the operator; and
storing the modified instructions in the instructions database, wherein the stored modified instructions are linked to the sensor signal and are identifiable using the context of the malfunction.

11. The method according to claim 1, wherein the machine is in a machine line for filling and packaging food and/or beverages.
